(19) United States
(12) Patent Application Publication
(10) Pub. No.: US 2002/0034825 A1
(43) Pub. Date: Mar. 21, 2002

(54) Method and testing liquid for the detection of acidic fluxing agent residue on electronic components

(76) Inventor: Helmut Schweigart, Ingolstadt (DE)

Correspondence Address: ROBERT W. BECKER & ASSOCIATES, Suite B, 11896 N. Highway 14, Tijeras, NM, 87059, US

(21) Appl. No.: 09/872,171

(22) Filed: May 31, 2001

(30) Foreign Application Priority Data
May 31, 2000 (DE) 100 27 236.3

(51) Int. Cl. G01N 31/22

(52) U.S. Cl. 436/100; 436/164; 436/163

(57) ABSTRACT

A process and testing liquid is provided for detecting acidic fluxing agent residue on electronic components. The testing liquid preferably contains a reactive dye or pigment that changes color when brought into contact with the contaminants on the electronic components; the testing liquid is subsequently removed from the electronic components by washing. The respective surfaces of the electronic components that show the corresponding color change contain contaminants. Preferably, the testing liquid contains the dye Nile blue and a surfactant.

### BACKGROUND OF THE INVENTION

The present invention relates to a process and a testing liquid for the detection of acidic fluxing agent residue on electronic components.

The reliability of electronic circuits is basically affected by contamination of the upper surfaces of the components. In particular, fluxing agents containing carbon acid groups work hygroscopically and, in connection with undesirable climatic conditions, such as moisture, can lead to electrochemical migration or to surface current leakage, both of which can affect the functioning of the electronic circuit or its components or, indeed, lead to their failure.

For the evaluation of existing contamination, in particular residue from fluxing agents which contain carboxylic acid groups, essentially only two procedures have been commonly used.

With the first procedure, the so-called ionic residual contamination is determined. In this process, the components to be checked are placed into distilled water and the conductivity of the water is measured. The conductivity rises with the presence of acidic groups of the fluxing agent residue. This conductivity is related to a sodium chloride mixture whose addition to the distilled water provides the same conductivity. The significance of this ionic residue contamination process is restricted, since the determined contaminants are generally not soluble in water and therefore are not included. Furthermore, the composition of the contaminants must be known in order, for example, to determine a threshold value for the corrosiveness of the contaminants. In addition, the investment in a testing apparatus for control of the ionic residue contaminants is relatively costly.

The second process is an expensive charge contrast procedure which is performed with a scanning electron microscope. With this process, contaminants on seemingly clean surfaces can be made visible first under light optic study conditions. This process is very expensive and is therefore used only rarely.

### SUMMARY OF THE INVENTION

It is an object of the present invention to provide a process for the detection of acidic fluxing agent residues on electronic components that, with inexpensive feasibility, leads to reliable results. A further object of the present invention is to provide a liquid which can be used with the inventive process.

With the inventive process, which addresses the above-stated objectives, a testing liquid is brought into contact with the electronic components. The testing liquid preferably contains a reagent pigment or dye which undergoes a color change when in contact with the contaminants, in particular the fluxing agent residue. After a sufficiently long reaction time, the testing liquid is washed off. The contaminated areas, in which contaminants remain which have reacted with color-changing dye or pigment, are then, as a correspondingly colored area, obtainable and identifiable directly through visual inspection or with the help of optical scanning. Thus, a reliable evaluation of the electronic components, with regard to their functional impairment through the documented residue, is possible.

### DESCRIPTION OF THE PREFERRED EMBODIMENTS

The process of the present invention is exceedingly simple, feasible, and applicable in a variety of applications, and also leads to reliable results. In addition, in view of the presence of fluxing agent residue on electronic components, the method of the present invention can be employed not only on simple printed circuit boards, but also on complex control structures having various components. The designated soldering process can be manual soldering, machine soldering, as with an SMD assembly, or dip soldering.

The pigment or dye used in the inventive method is one which shows a color reaction with the groups of the fluxing agent residue that are in question. The reaction of the dye or pigment with the acidic activator residue of the fluxing agent triggers a change in the chemical structure of the pigment, which leads to a discoloration. The mostly colorless activator residues are therefore observable.

Excellent results were obtained with Nile blue (5-Amino-9(diethylamino) benzo [a]phenoxazine-7-lumhydrogen sulfate), which preferably is utilized as Nile blue-hydrogen sulfate. It can also be utilized in the form of a sulfate, chloride or other salt. The acidic groups, for example carboxylic acid, that is, the carboxyl groups from the fluxing agent, lead to a blue coloring which is based on an acid-base balance reaction according to the following, whereby a sulfate is respectively substituted by carboxylation.

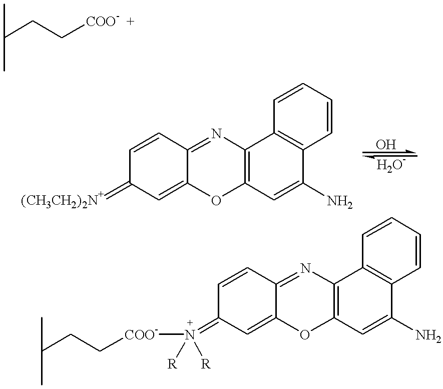

With the blue coloration of the pigment Nile blue, residue of the entire fluxing agent can be detected, particularly if the residue contains carbonxylic acid. Also, residues even from “No Clean” fluxing agents, which are particularly lacking in solids, are detectable with Nile blue.

A problem that frequently occurs in practice is when the pigment or dye of the testing liquid does not come near the reactive groups of the contaminants. Providing the preferably aqueous testing liquid with a surfactant in order to reduce the surface tension of the testing liquid, thereby improving the wetting capability of the testing fluid, can solve this problem. Preferably, non-ionized surfactants are used, whose residues are chemically inert and undergo no reaction with the dye.

By way of example, the following surfactants would be suitable:

C12/C14 Fat alcohol-polyglycol-ether with 3 ethyl-oxide units; or

C14/C15 Oxo-alcohol-polyglycol-ether with 3 ethyl-oxide units; or

C12/C15 Oxo-alcohol-polyglycol-ether with 3 to 5 ethyl-oxide units.

Very favorable wetting capability, especially for synthetic surfaces, was achieved with a fluorine surfactant. Such fluorine surfactants reduce the surface tension of aqueous solutions from approximately 20 mN/m². Preferably, a fluorine surfactant is used having the following universal formula:

Rf CH2CH20(CH2CH20)×H, whereby 3≦x≦5 and Rf=F(CF2-CF2) n, with 3≦n≦8.

The above surfactant or other surfactants can exist singly or in combination.

Advantageously, the testing liquid has the following composition (by weight percentage):

| | |
|---|---|
| Nile Blue: | 0.02 to 0.06%; |
| Surfactant: | 0.05 to 0.2%; |
| Desalinated water: | approximately 100%. |

Particularly advantageous is 0.04% by weight of Nile blue, 0.1% by weight of a fluorine surfactant, and 99.86% by weight of water.

By way of demonstration and example, the inventive method is performed as follows:

The testing liquid is selectively or, if need be, applied extensively to the soldering point, or as the case may be, to the entire surface of the electronic component to be studied. After a working period of about a minute, the distilled or completely desalinated water is thoroughly and vigorously processed for about 30 seconds. The components are then dried, whereby, for example, dry and oil-free compressed air can be used supportingly.

If no coloration occurs, it can thus be concluded that the components are free from activator residue, that is, acid groups. Blue or blue-violet coloration (with the pigment Nile Blue), which is visible with the naked eye or in the case of a very thin film, first under the observation of the microscope by magnifying about 20 times, shows the existence of activator residue, that is, contaminants, which can have grave consequences for the functionality of the electronic components.

It should be understand that the analysis of the coloration also can be performed with the assistance of a scanning device, which scans the entire surface of the electronic component and automatically includes the respective spectral colored area.

With numerous dyes and pigments, in particular with Nile blue, strong alkaline groups, such as are present in cleaning agents, can also be detected, for example, amine components. Such strong alkaline groups, when contacted with Nile Blue, show a red-violet coloration, which performs a decomposition, for example of the dye Nile Blue Sulfate which is alkaline with a pH>10.2. No coloration means, therefore, that none of the above-named reactive groups are present.

The specification incorporates by reference the disclosure of German priority document 100 27 236.3 filed May 31, 2000.

The present invention is, of course, in no way restricted to the specific disclosure of the specification, but also encompasses any modifications within the scope of the appended claims.

What is claimed is:

1. A method for detecting acidic fluxing agent residue on electronic components, said process comprising the steps of:
contacting a testing liquid with the electronic components, said testing liquid containing a reactive dye of a selected color, wherein said reactive dye changes color when contacting said acidic fluxing agent residue;
rinsing off the testing liquid from the electronic components; and
determining an area of color change on a surface of said electronic components.

2. The method of claim 1, wherein said reactive dye is Nile blue.

3. The method of claim 2, further comprising the step of adding a surfactant to said testing liquid to improve the wetting action of said testing liquid.

4. The method of claim 3, wherein the surfactant is a polyglycol-ether.

5. The method of claim 4, wherein the surfactant is a C12/C15 oxo-alcohol-polyglycol-ether.

6. The method of claim 5, wherein the surfactant contains 3 to 5 ethyl-oxide units.

7. The method of claim 3, wherein the surfactant is a fluorine surfactant.

8. The method of claim 7, wherein the fluorine surfactant has the formula Rf CH2CH20(CH2CH20) x H, whereby 3≦x≦5 and Rf=F(CF2-CF2) n, with 3≦n≦8.

9. The method of claim 2, wherein the testing liquid comprises 0.02 to 0.06% by weight of Nile blue, 0.05 to 0.2% by weight of a surfactant, and approximately 100% by weight of desalinated water.

10. A testing liquid for detecting acidic fluxing agent residue on electronic components, said testing liquid comprising:
a reactive dye of a selected color, wherein said reactive dye changes color when brought into contact with said acidic fluxing agent residue.

11. The testing liquid of claim 10, wherein said testing liquid further comprises a surfactant for improving the wetting capability of said testing liquid.

12. The testing liquid of claim 11, wherein the surfactant is a polyglycol-ether.

13. The testing liquid of claim 12, wherein the surfactant is a C12/C15 oxo-alcohol-polyglycol-ether.

14. The testing liquid of claim 13, wherein the surfactant contains 3 to 5 ethyl-oxide units.

15. The testing liquid of claim 11, wherein the surfactant is a fluorine surfactant.

16. The testing liquid of claim 15, wherein the fluorine surfactant has the formula Rf CH2CH20(CH2CH20) x H, whereby 3≦x≦5 and Rf=F(CF2-CF2) n, with 3≦n≦8.

17. The testing liquid of claim 10, wherein the reactive dye is Nile blue.

18. The testing liquid of claim 17, wherein the testing liquid comprises 0.02 to 0.06% by weight of Nile blue, 0.05 to 0.2% by weight of a surfactant, and approximately 100% by weight of desalinated water.
